(19) United States
(12) Patent Application Publication
(10) Pub. No.: US 2024/0418589 A1
(43) Pub. Date: Dec. 19, 2024

(54) Compact Six Degree of Freedom Force Sensor and Method

(71) Applicants: Kenneth Perlin, New York, NY (US); Charles Hendee, Manteca, CA (US)

(72) Inventors: Kenneth Perlin, New York, NY (US); Charles Hendee, Manteca, CA (US)

(73) Assignees: New York University, New York, NY (US); Tactonic Technologies, LLC, New York, NY (US)

(21) Appl. No.: 18/739,227

(22) Filed: Jun. 10, 2024

Related U.S. Application Data
(60) Provisional application No. 63/472,725, filed on Jun. 13, 2023.

(51) Int. Cl. G01L 5/161; B25J 15/10; B25J 19/02; G01L 5/22

(52) U.S. Cl. CPC G01L 5/161; B25J 15/10; B25J 19/02; G01L 5/228

(57) ABSTRACT

A sensor having a plurality of sensing elements which sense six degrees of freedom of force on a touch layer. The sensor includes a computer which causes prompting signals to be sent to the sensing elements and reconstructs six degrees of freedom of force on the layer from data signals received from the sensing elements. A method for sensing forces. A robotic hand. having a finger having a tip with sensors on the tip. Alternatively, the sensor includes a ribbon cable.

### CROSS-REFERENCE TO RELATED APPLICATIONS

This is a nonprovisional of U.S. provisional application Ser. No. 63/472,725 filed Jun. 13, 2023, incorporated by reference herein.

### FIELD OF THE INVENTION

The present invention is related to a 6 Degree of Freedom (DOF) force sensor. More specifically, the present invention is related to a 6DOF force sensor which uses sensing elements that vary current in response to compressive forces upon a touch layer.

### BACKGROUND OF THE INVENTION

This section is intended to introduce the reader to various aspects of the art that may be related to various aspects of the present invention. The following discussion is intended to provide information to facilitate a better understanding of the present invention. Accordingly, it should be understood that statements in the following discussion are to be read in this light, and not as admissions of prior art.

The current generation of 6DOF isometric force sensors are heavy and bulky and cost upwards of several thousand dollars. What is needed is a 6DOF force sensor which is lightweight and compact. Prior art deals with such problems by using a relatively large and bulky unit that in one implementation contains multiple strain gauges. Such solutions are not adequate for use in situations where the object to be manipulated is small and lightweight. The present invention solves that problem.

### BRIEF SUMMARY OF THE INVENTION

The present invention pertains to a sensor. The sensor comprises a touch layer. The sensor comprises a plurality of sensing elements which sense six degrees of freedom of force on the touch layer. The sensor comprises a computer in communication with the sensing elements which causes prompting signals to be sent to the sensing elements and reconstructs six degrees of freedom of force on the touch layer from data signals received from the sensing elements.

The present invention pertains to a method for sensing forces having the steps of applying a force to a touch layer. There is the step of sending prompting signals to a plurality of sensing elements by a computer. There is the step of receiving data signals from the sensing elements by the computer. There is the step of identifying six degrees of freedom of the force on the touch layer by the computer from the data signals received from the sensing elements.

The present invention pertains to a robotic hand. The robotic hand comprises a finger having a tip. The robotic hand comprises a plurality of sensors on the fingertip which together function as a 6° of freedom sensor over the fingertip, where each sensor of the plurality of sensors is a 6° of freedom sensor.

The present invention pertains to a sensor. The sensor comprises six sensing elements with a touch layer. Each of the sensing elements varies current in response to compressive forces upon the touch layer. The sensor comprises a ribbon cable having a power trace to provide power to the six sensor elements, and six return traces upon which signals from the six sensor elements are sent, with one return trace of the six return traces connected to one sensor element of the six sensor elements. The sensor comprises a computer connected to the power trace and the six return traces to provide power to the six sensor elements and receive signals from the six sensor elements.

### BRIEF DESCRIPTION OF THE DRAWINGS

FIG. 1A shows a sensor of the claimed invention.

FIG. 1B shows a power trace of the claimed invention.

FIG. 1C shows return traces of the claimed invention.

FIG. 1D shows the scale in regard to the grid spacing, which is 1 mm.

FIG. 1E shows a perspective exploded view of the sensor.

FIG. 2 shows a cross-sectional view of a top layer.

FIG. 3 shows a cross-sectional view of a bottom layer.

FIG. 4 shows a top layer, bottom layer, controller, power/dataport, and an FPC connector.

FIG. 5 shows a finger on a sensor.

FIG. 6A shows a side view of sensors on a robot finger.

FIG. 6B shows a top view of sensors on a robot.

FIG. 7 shows a top view of an alternative embodiment of a sensor of the claimed invention.

FIG. 8 shows a front view of a sensor of the alternative embodiment.

FIG. 9 shows a schematic representation of the 6° of freedom of the applied force.

FIG. 10 shows a schematic representation of a circuit of the sensor.

### DETAILED DESCRIPTION OF THE INVENTION

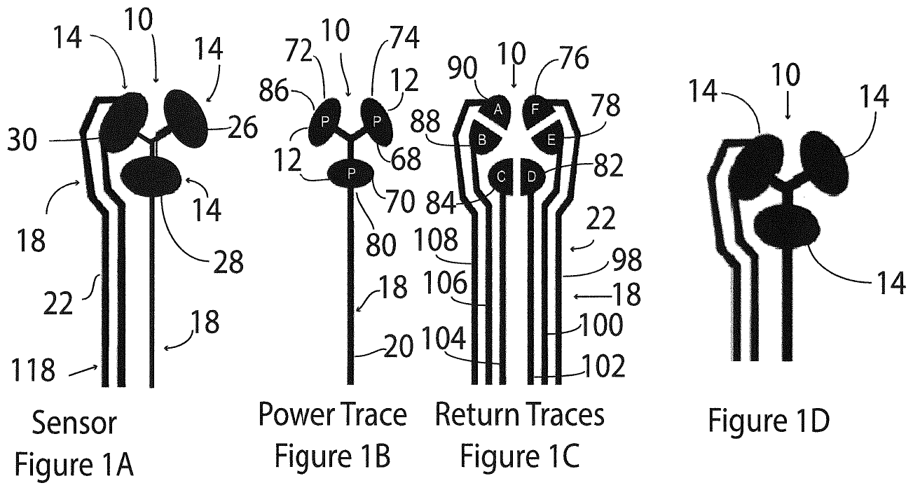

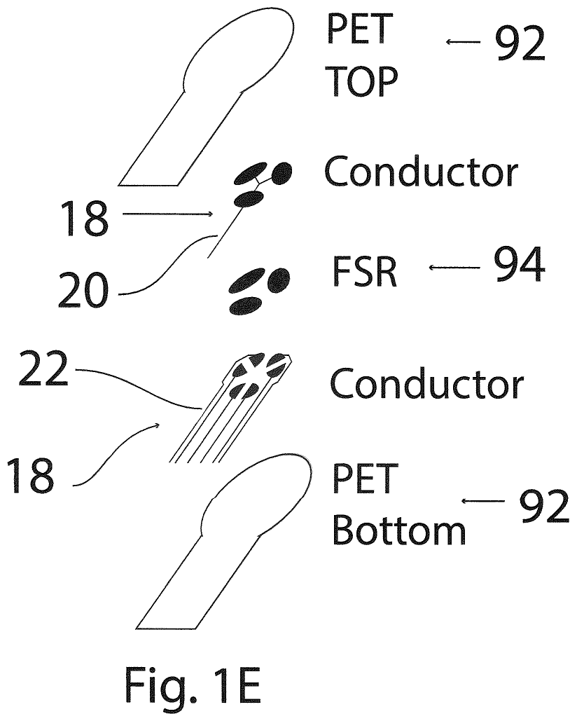

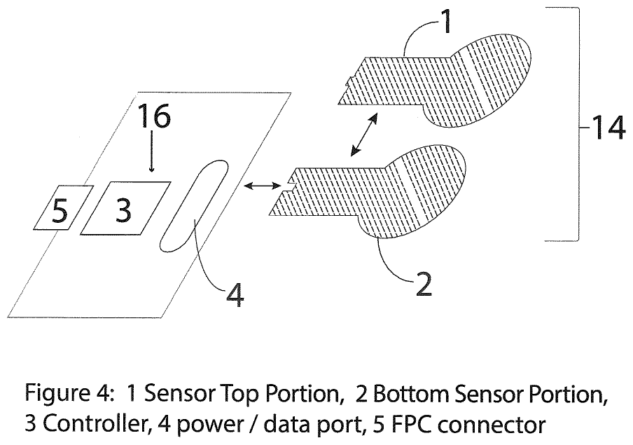

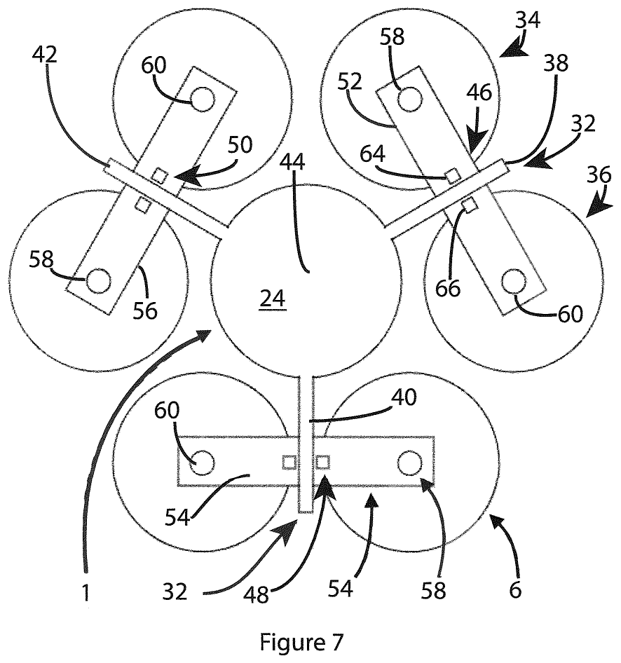

Referring now to the drawings wherein like reference numerals refer to similar or identical parts throughout the several views, and more specifically to FIGS. 1A-1E and 7 thereof, there is shown a sensor 10. The sensor 10 comprises a touch layer 12. The sensor 10 comprises a plurality of sensing elements 14 which sense six degrees of freedom of force on the touch layer 12. The sensor 10 comprises a computer 16, as shown in FIG. 4, in communication with the sensing elements 14 which causes prompting signals to be sent to the sensing elements 14 and reconstructs six degrees of freedom of force on the touch layer 12 from data signals received from the sensing elements 14.

Each sensing element may include at least two conductors 18. One conductor of the two conductors 18 being a power trace 20 which provides prompting signals to the sensing element from the computer 16, and a second of the two conductors 18 being a return trace 22 on which the data signals from the sensing element are sent to the computer 16. The touch layer 12 may include a contact surface 24 to which six degrees of force can be applied, 3DOF of linear force and 3DOF of rotational torsion. There may be a first sensing element 26, a second sensing element 28, and a third sensing element 30.

Each sensing element may include an activator 32 and a first patch 34 having at least a portion under the activator 32, and a second patch 36 having at least a portion disposed under the activator 32, as shown in FIG. 7. The activator 32 of the first sensing element 26 may include a first rod 38 attached to the contact surface 24. The activator 32 of the second sensing element 28 may include a second rod 40 attached to the contact surface 24. The activator 32 of the third sensing element 30 may include a third rod 42 attached to the contact surface 24.

The contact surface 24 may have a center 44. The activator 32 of the first sensing element 26 may have a first guide 46 that abuts the first rod 38, which allows free movement of the contact surface 24 and the first rod 38 radially, but not angularly, around the center 44. The activator 32 of the second sensing element 28 may have a second guide 48 that abuts the second rod 40, which allows free movement of the contact surface 24 and the second rod 40 radially, but not angularly, around the center 44. The activator 32 of the third sensing element 30 may have a third guide 50 that abuts the third rod 42, which allows free movement of the contact surface 24 and the third rod 42 radially, but not angularly, around the center 44.

The activator 32 of the first sensing element 26 may include a first beam 52 attached to the first guide 46. The activator 32 of the second sensing element 28 may include a second beam 54 attached to the second guide 48. The activator 32 of the third sensing element 30 may include a third beam 56 attached to the third guide 50. The first beam 52 may have a first contact point 58 with the first patch 34 under the first beam 52 and a second contact point 60 with the second patch 36 under the first beam 52. The second beam 54 may have a first contact point 58 with the first patch 34 under the second beam 54 and a second contact point 60 with the second patch 36 under the second beam 54, and the third beam 56 has a first contact point 58 with the first patch 34 under the third beam 56 and a second contact point 60 with the second patch 36 under the third beam 56.

Each first patch 34 and each second patch 36 may be a downward pressure sensor 6. The sensor 10 may include a spring 62 disposed under the first beam 52 and between the first contact point 58 and the second contact point 60 to support the first beam 52. The first guide 46 may have a first post 64 and a second post 66 with the first rod 38 disposed between the first post 64 and the second post 66. The base of the spring acts as in a fixed in position, causing it to act as a rotational pivot which thereby constrains the beam to rotate around the base of the spring, rather than translate laterally, when lateral force is applied to the beam by the rod.

In an alternative embodiment, and referring to FIGS. 1A, 1B, IC, 1D, and 1E, the contact surface 24 may include a first bump 68, a second bump 70, and a third bump 72. The first sensing element 26 may include a first top layer 74 to which the first bump 68 is attached, a first bottom layer 76 having at least a portion disposed under the first top layer 74, and a second bottom layer 78 having at least a portion disposed under the first top layer 74. The second sensing element 28 may include a second top layer 80 to which the second bump 70 is attached, a third bottom layer 82 having at least a portion disposed under the second top layer 80, and a fourth bottom layer 84 having at least a portion disposed under the second top layer 80. The third sensing element 30 may include a third top layer 86 to which the third bump 72 is attached, a fifth bottom layer 88 having at least a portion disposed under the third top layer 86, and a sixth bottom layer 90 having at least a portion disposed under the third top layer 86.

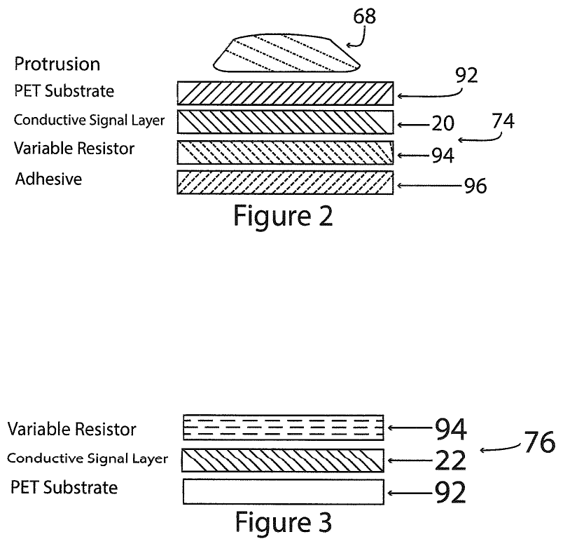

The first, second and third top layers 74, 80, 86 each may include a substrate 92 in contact with the first, second and third bumps 68, 70, 72, respectively; the power trace 20 in contact with the substrate 92, a variable force resistive material 94 in contact with the power trace 20 with the power trace 20 between the substrate 92 and the force resistive material 94, and adhesive 96 in contact with the force resistive material 94, as shown in FIGS. 1E and 2. Each bottom layer may include force resistive material 94, the return trace 22 in contact with the variable force resistive material 94 of the bottom layer, and a substrate 92 in contact with the force resistive material 94 of the bottom layer with the force resistive material 94 of the bottom layer between the substrate 92 of the bottom layer and the return trace 22, is shown in FIG. 3.

The return trace 22 of the first bottom layer 76 may be a first return trace 98. The return trace 22 of the second bottom layer 78 may be a second return trace 100. The return trace 22 of the third bottom layer 82 may be a third return trace 102. The return trace 22 of the fourth bottom layer 84 may be a fourth return trace 104. The return trace 22 of the fifth bottom layer 88 may be a fifth return trace 106. The return trace 22 of the sixth bottom layer 90 may be a sixth return trace 108, shown in FIG. 1C.

The force resistive material 94 of the first top layer 74 may contact the force resistive material 94 of the first bottom layer 76 and the second bottom layer 78 with the adhesive 96 of the first top layer 74 disposed between the first top layer 74 and the first and second bottom layers 76, 78 where there is no force resistive material 94. The force resistive material 94 of the second top layer 80 may contact the force resistive material 94 of the third bottom layer 82 and the fourth bottom layer 84 with the adhesive 96 of the second top layer 80 disposed between the second top layer 80 and the third and fourth bottom layers 82, 84 where there is no force resistive material 94. The force resistive material 94 of the third top layer 86 may contact the force resistive material 94 of the fifth bottom layer 88 and the sixth bottom layer 90 with the adhesive 96 of the third top layer 86 disposed between the third top layer 86 and the fifth and sixth bottom layers 88, 90 where there is no force resistive material 94. Using the FSR-based technique described here, the sensor 10 can be as small as 5×5×0.25 mm, and could be sold for well under $1000.

The present invention pertains to a method for sensing forces having the steps of applying a force to a touch layer 12. There is the step of sending prompting signals to a plurality of sensing elements 14 by a computer 16. There is the step of receiving data signals from the sensing elements 14 by the computer 16. There is the step of identifying six degrees of freedom of the force on the touch layer 12 by the computer 16 from the data signals received from the sensing elements 14.

The present invention pertains to a robotic hand 112, as shown in FIGS. 6A and 6B. The robotic hand 112 comprises a finger 114 having a tip 116. The robotic hand 112 comprises a plurality of sensors 10 on the finger 114 tip 116 which together function as a 6° of freedom sensor over the finger 114 tip 116, each sensor 10 of the plurality of sensors 10 is a 6° of freedom sensor.

The present invention pertains to a sensor 10, as shown in FIGS. 1A-1E and 4. The sensor 10 comprises six sensing elements 14 with a touch layer 12. Each of the sensing elements 14 varies current in response to compressive forces upon the touch layer 12. The sensor 10 comprises a ribbon cable 118 having a power trace 20 to provide power to the six sensor elements, and six return traces upon which signals from the six sensor elements are sent, with one return trace of the six return traces connected to one sensor element of the six sensor elements. The sensor 10 comprises a computer 16 connected to the power trace 20 and the six return traces to provide power to the six sensor elements and receive signals from the six sensor elements.

### Hardware:

A computer 16.
A ribbon cable 118 with 7 conductive traces.
A sensor 10 that varies current in response to compressive forces upon its surface.

Any type of sensor can be used that can vary current in response to compressive force normal to its surface. In one embodiment, the sensor 10 is based on force sensitive resistance (FSR). In another embodiment, the sensor 10 is piezoelectric.

Three small raised bumps 68, 70, and 72, are affixed to the touch surface 12 of the sensor 10, one bump wherever the letter P appears in FIGS. 1A-1D.

The sensor 10 comprises two layers with each layer having a substrate 92 (in this embodiment, the substrate 92 is a 7 mil thick pet), conductive traces (both signal/power and return traces consisting of an electrically conductive material such as Dupont's PE 827 silver composite conductor, which is used in this embodiment), and a variable force sensing element (in this embodiment a semi-conductive mix of carbon and a silver based conductive element is used to create a variable force resistive material [FSR]). One layer (the top layer) of the sensor 10 will also have an adhesive 96 (used to hold the two layers together) and a spacer or protrusion or bump over each P pad, thus creating additional height (between 0.2-0.25 mm in this embodiment). The bottom layer comprised of patches A-F of FIG. 1C, and formed as shown in FIG. 3 as a separate stack for each patch A-F, has A and B under a first P pad, C and D under a second P pad, and E and F under a third P pad. FIG. 1E shows a perspective exploded view of the relationship of the various elements.

FIG. 4 shows the sensor top portion 1, the sensor bottom portion 2, the computer 3, the power/data port 4, and the FPC connector 5.

The only conductive parts of one sensor layer that faces and touches the other is the fsr on each layer. That is what acts as a variable resistor. The adhesive 96 is deposited in areas that are not covered by fsr. The fsr is facing fsr on the other layer. Adhesive 96 is only needed on one layer. From a practical point of view, it acts as a dielectric as well.

### Internal Operation:

Interaction between the computer 16 and the sensor 10 is as follows:
1. The computer 16 continually applies constant current via trace P.
2. Variable current continually returns to the computer 16 via traces A through F.

Pressure applied directly downward onto the bump that is centered between regions C and D in FIG. 1 results in an equal increase in current to both of their respective traces. Meanwhile, pressure applied to the bump laterally in the direction from C to D causes a tilting force in the region around the bump, causing an increase in current in the D trace and a corresponding decrease in current in the C trace. A similar effect occurs with respect to pressure applied to the bump over regions A and B and the bump over regions E and F. In this way, the 6 degrees of freedom of force that can be applied to the surface—3 degrees of freedom of linear force and 3 degrees of rotational torque—result in changes to current in the six traces A through F.

The computer 16 derives the three degrees of freedom of measured linear force as follows:

$$Linear force in X : ( D - C ) + ( A - B ) / 2 + ( E - F ) / 2$$

$$Linear force in Y : ( A - B ) * √ 3 / 2 + ( F - E ) * √ 3 / 2$$

$$Linear force in Z : ( A + B ) + ( C + D ) + ( E + F )$$

The computer 16 derives the three degrees of freedom of measured rotational torque as follows:

$$Torque about X : ( E + F ) - ( A + B )$$

$$Torque about Y : ( A + B ) / 2 + ( E + F ) / 2 - ( C + D )$$

$$Torque about Z : ( B - A ) + ( D - C ) + ( F - E )$$

### User Experience:

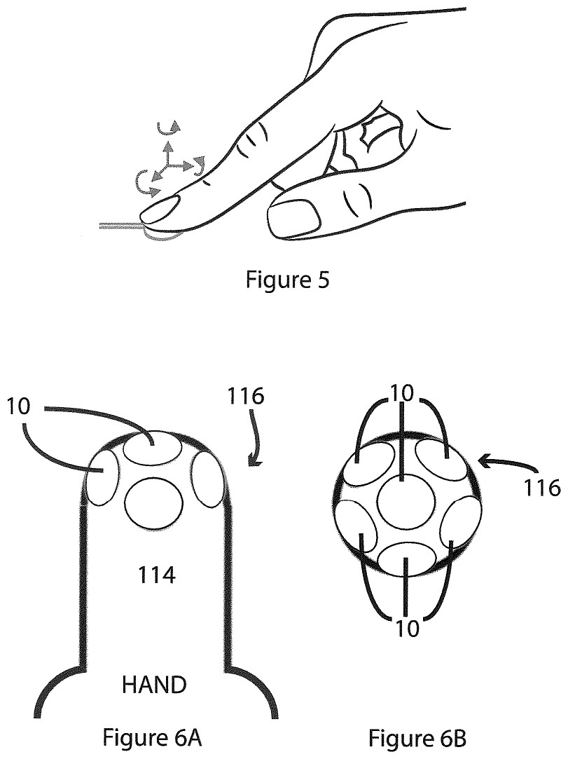

A person placing their finger 114 on the sensor 10 is able to apply six dimensions of isometric force—three linear and three rotational. Contact friction prevents the finger 114 from slipping across the sensor 10 surface, as shown in FIG. 5.

Alternatively, one or more sensors 10 can be arranged about the surface of a robot finger 114. For example, six sensors 10 are arranged around the tip 116 of a robot finger 114 in FIGS. 6A and 6B. Each of the six sensors 10 is a complete 6DOF sensor, with its own 3 bumps and seven electrical connections. The advantage of this arrangement is that the finger 114 can function as a 6DOF sensor over the entire hemisphere of the finger 114 tip 116.

### Use Cases:

### Robot Hand Manipulator

A robot hand 112 that manipulates a physical object needs to properly sense the forces of the object against the robot's fingers in order to determine the optimal control strategy for grasping and moving the object. Current small form factor force sensors detect only downward force, perpendicular to the surface of the robot finger 114.

This configuration is inadequate for dealing with situations where an object may be about to slip out of the robot hand's grasp because of the three dimensions of turning force (torque) or the two dimensions of linear force along the surface of the robot finger (shear). Therefore, it is extremely useful for a force sensor to be able to sense three degrees of torque as well as all three degrees of linear force (downward force directly into the robot finger 114 as well as the two additional degrees of shear force at the point of contact).

For example, if a robot is picking up an object from a table by grasping the object between a robot thumb and a robot forefinger, it may be the case that the weight of the object is not balanced. In one case, there might be greater weight toward the thumb of the object. If the robot were merely to squeeze the object between thumb and forefinger and begin to lift, then the unbalanced weight of the object would cause the object to rotate so that the side which is toward the thumb moves downward. This would cause the object to fall out of the grasp of the robot. By use of the present invention, the robot will be able to detect a greater downward shear force on the surface of the robot's thumb than on the robot's forefinger. The robot can then respond by rotating the robot hand 112 until the downward shear force on the robot's thumb and forefinger are equal. This indicates that in this new rotated orientation, the weight of the object is horizontally centered on the object, and that it is therefore safe for the robot hand 112 to lift the object up off the table.

### Controls for Handheld Consumer Devices

In another use scenario, small consumer devices, such as cameras, have very limited space for button controls. Also, when the user is operating the camera, they often cannot see these controls, because the user is looking through the lens. The small form factor six degree of freedom force sensor here described is able to serve as a multi-purpose control, since each degree of freedom provides an independent degree of control. Therefore, to effect multiple controls, such as shutter speed or focal length, the user need only keep their finger 114 in a single location on the camera surface, rather than needing to fumble to find the positions of multiple control buttons.

For example, the user might, while keeping their finger 114 on the button, push forward to zoom in, while simultaneously leaning their finger 114 forward or back to adjust focus, and pushing left or right to close down or open up the shutter. When the user is ready to shoot, they press down on the button.

Six degree of freedom force sensors in the current state of the art are prohibitively expensive as well as being too large and heavy to be used for this purpose.

### Walking Cane

It would be useful to place this sensor 10 into a walking cane. In one embodiment, the sensor 10 would be located between the handle at the top of the cane and the main shaft of the cane. In addition to downward force, measuring how much weight the user is exerting as they lean on the cane, the sensor 10 would also measure twisting forces applied by the user's wrist (torsion about the vertical axis), and pitch and yaw forces applied by the user's wrist (torsion about the two horizontal axes). The time-varying magnitude of these torsional forces could be either stored in the memory of a microcomputer within the cane, or else wirelessly transmitted to a remotely located base computer 16. In either case, the gathered data could be used by a physical therapist to assess the level of instability of the user, in order to help design a custom regime of physical therapy.

### Alternative Embodiment

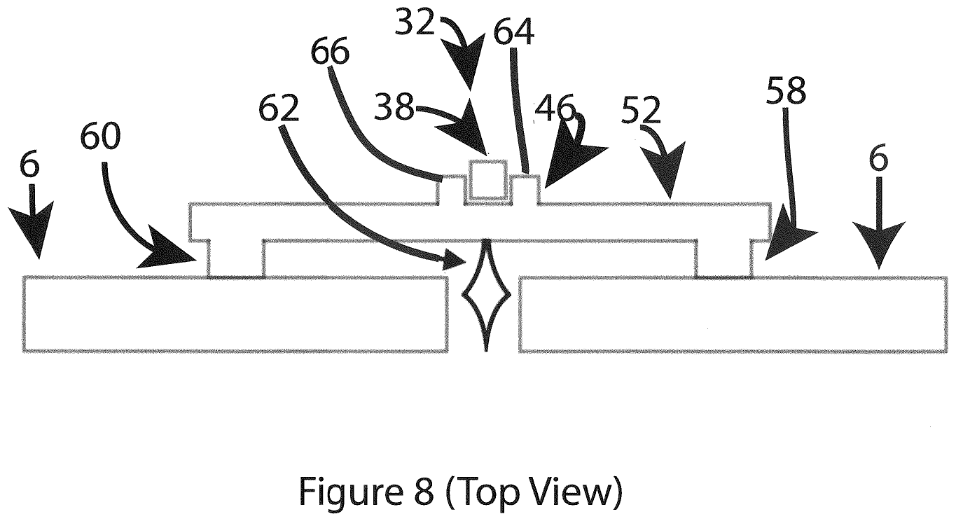

Mechanical components of a 6 DOF Optical sensor (with reference to FIG. 7)
1. A contact surface 24 that the user can touch and thereby apply six degrees of force (3DOF of linear force as well as 3DOF of rotational torsion)
2. Three rods 38, 40, 42 rigidly attached to the contact surface 24.
3. Three guides 46, 48, 50 that abut the 3 rods 38, 40, 42, respectively, which allow free movement of contact surface 24 and 3 rods 38, 40, 42, respectively, radially, but not angularly, around the center of contact surface 24.
4. Three beams 52, 54, 56 rigidly attached to the three guides 46, 48, 50, respectively.
5. Attachment points 58, 60 between beams 52, 54 and 56 and downward pressure sensors 6.
6. Six downward pressure sensors 6, which in one embodiment can be FTIR sensors, that measure force exerted at attachment points 58, 60 at each downward pressure sensor 6.
7. A small spring 62 (only visible in FIG. 8) that supports the beam 52 at its center.

FIG. 8 shows a front view. One rod 64 nestles between posts 64, 66 of guide 46, which connect a support beam 52. The beam 52 connects to 2 attachment points 58, 60, which push down onto pressure sensor 6. Support spring 62 ensures that lateral force from the first rod 64 is converted to rotational torque about the base of the spring 62.

### Step by Step User Operation

The user places the tip 116 of a finger 114 upon the contact surface 24. The user can then apply variable force that combines downward, north, south, east and west linear force, as well as torsion in the form of twisting and leaning east/west and leaning north/south. In total, this represents six degrees of force, three of which are linear and three of which are torsional.

### Step by Step Internal Operation

When the user exerts force upon the contact surface 24, the force is distributed to the three rods 38, 40, 42, which, constrained by the three guides 46, 48, 50 and three beams 52, 54, 56, in turn exert force on the three beams 52, 54, 56, in a combination of two directions: (a) downward, and (b) laterally against the three guides 46, 48, 50.

Meanwhile, support spring 62 exerts a constant upward force upon the center of the respective beam.

Any lateral movement of each rod is converted to rotational movement by the physical constraint of the attachment of the respective beam to the respective support spring 62, which supports the respective beam from underneath at the respective beam's center. The center point of this rotation of the beam is the base of the spring upon which it rests. The resulting rotational torque increases the downward force on one end of the beam while decreasing the downward force on the other end of the beam. In this way, the two degrees of freedom of radial and downward force imparted by a rod upon the beam under it are converted into downward forces upon the beam at each of its two attachment points. These forces are then transmitted by the attachment points to the corresponding two downward pressure sensors 6 that lie directly beneath those attachment points.

Because of the above-described mechanical arrangement, downward force of a rod upon a beam is converted into an equal downward force on the two adjoining sensors, whereas lateral force by a rod upon a beam is converted into differential downward force: more force on one of the two downward pressure sensors under the beam and less force on the other.

When taken together, the six degrees of force (three translational and three torsional) exerted by the user's finger 114 upon the contact surface 24 is converted into six downward forces—one upon each of the six downward-force sensors 6.

### Analysis

### Let Us Define:

The X axis to the right in FIG. 7
The Y axis upward in FIG. 7
The Z axis out of the page in FIG. 7

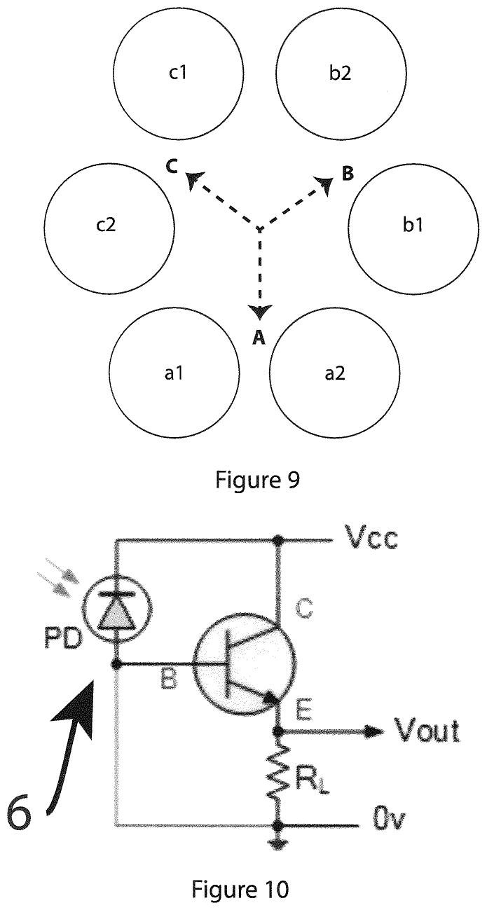

The six sensors and three principal directions can be labeled as in FIG. 9.

Let us break down the six degrees of freedom of applied force as follows:
(1) Applied linear force along the Z axis
(2) Applied torsional force around the Z axis
(3) Applied linear force within the XY plane
(4) Applied torsional force around X and Y axes

Linear force in the XY plane can be linearly decomposed into linear force in X and linear force in Y. For the purposes of this analysis, this force is decomposed into three linear forces in three equilateral directions. From symmetry, it is known these three forces must always sum to zero.

Linear force in direction A has no effect on the two sensors a1 and a2 adjacent to direction A, since the force direction is entirely radial. In directions B and C the resulting force has a radial component of 50%, because the direction of the force is 120 degrees from those directions, and the cosine of that angle is −0.5. The resulting radial forces at B and C cause a lifting (negative) force over sensor b2 and c1, and a pressing (positive) force over sensors b1 and c2.

Since half of applied force F is distributed to direction B and the other half to direction C, the net effect is a downward force amplitude at b1 of +F/4, at b2 of −F/4, at c1 of −F/4 and at c2 of +F/4.

Similarly, torsion by tilting toward A produces a torque F that causes a downward force +F/2 at sensors a1 and a2. Meanwhile, the upward pull at B and C from this torque produces an upward force-F/4 at each of b1, b2, c1 and c2.

Similarly, torsion by rotating about the A axis produces a positive (downward) force upon a1, c1 and c2 and a negative (upward) force upon a2, b1 and b2.

Note that in all of the above cases, there is no net rotational force about Z and no net downward force in the Z direction.

To summarize, the six degrees of force/torque are each proportional to, respectively:

$$Linear force toward A : + b 1 - b 2 - c 1 + c 2$$

$$Rotational torque about A : + a 1 - a 2 - b 1 - b 2 + c 1 + c 2$$

$$Linear force toward B : - a 1 + a 2 + c 1 - c 2$$

$$Rotational torque about B : + a 1 + a 2 + b 1 - b 2 - c 1 - c 2$$

$$Linear force toward C : + a 1 - a 2 - b 1 + b 2$$

$$Rotational torque about C : - a 1 - a 2 + b 1 + b 2 + c 1 - c 2$$

$$Linear force toward Z : + a 1 + a 2 + b 1 + b 2 + c 1 + c 2$$

$$Rotational torque about Z : - a 1 + a 2 - b 1 + b 2 - c 1 + c 2$$

To change coordinates from A, B, C to X, Y:

$$Force in X = + Force in B - Force in C$$

$$Force in Y = - Force in A$$

### Electronics

FTIR sensors are well known in the art, and no innovation is claimed for this component. In one implementation the illumination component for each FTIR sensor can be an IN-S32HSNPD SMD 3.0×2.0 PCB Type Photodiode from Inolux. The sensor component can be an LZ1-00R602 LED ENGIN LuxiGen from OSRAM. These two components are connected to form the six required FTIR sensors.

As can be seen in FIG. 10, which shows a schematic of the circuit for one individual sensor 10, each of the six sensors is illuminated by a constant source of infrared (IR) illumination from an IR light emitting diode (LED).

A microprocessor provides constant 5v voltage input to the LEDs. Variation in downward pressure upon each sensor 10 is converted into a change in voltage across the circuit to which the sensor 10 is connected.

Periodically, the microprocessor prompts a data readout, causing the six sensor output voltages to be read into six analog-to-digital input pins of the microprocessor, whereupon the voltages are converted to digital values which are then sent by the microprocessor to a host computer 16 for analysis, as described above in the “Analysis” section above. Communication between microprocessor and host computer 16 is implemented via standard techniques of serial digital communication. The power trace provides power to each sensor element and the 6 return traces from the six downward pressure sensors 6 operate in the way as described above in the first embodiment.

Although the invention has been described in detail in the foregoing embodiments for the purpose of illustration, it is to be understood that such detail is solely for that purpose and that variations can be made therein by those skilled in the art without departing from the spirit and scope of the invention except as it may be described by the following claims.

The invention claimed is:

1. A sensor comprising:
a touch layer;
a plurality of sensing elements which sense six degrees of freedom of force on the touch layer; and
a computer in communication with the sensing elements which causes prompting signals to be sent to the sensing elements and reconstructs six degrees of freedom of force on the touch layer from data signals received from the sensing elements.

2. The sensor of claim 1 wherein each sensing element includes at least two conductors, one conductor of the two conductors being a power trace which provides prompting signals to the sensing element from the computer, and a second of the two conductors being a return trace on which the data signals from the sensing element are sent to the computer.

3. The sensor of claim 2 wherein the touch layer includes a contact surface to which six degrees of force can be applied, 3DOF of linear force and 3DOF of rotational torsion.

4. The sensor of claim 3 wherein there is a first sensing element, a second sensing element, and a third sensing element.

5. The sensor of claim 4 wherein each sensing element includes an activator and a first patch having at least a portion under the activator, and a second patch having at least a portion disposed under the activator.

6. The sensor of claim 5 wherein the activator of the first sensing element includes a first rod attached to the contact surface, the activator of the second sensing element includes a second rod attached to the contact surface, and the activator of the third sensing element includes a third rod attached to the contact surface.

7. The sensor of claim 6 wherein the contact surface has a center, and the activator of the first sensing element has a first guide that abuts the first rod, which allows free movement of the contact surface and the first rod radially, but not angularly, around the center; the activator of the second sensing element has a second guide that abuts the second rod, which allows free movement of the contact surface and the second rod radially, but not angularly, around the center; and the activator of the third sensing element has a third guide that abuts the third rod, which allows free movement of the contact surface and the third rod radially, but not angularly, around the center.

8. The sensor of claim 7 wherein the activator of the first sensing element includes a first beam attached to the first guide, the activator of the second sensing element includes a second beam attached to the second guide, and the activator of the third sensing element includes a third beam attached to the third guide.

9. The sensor of claim 8 wherein the first beam has a first contact point with the first patch under the first beam and a second contact point with the second patch under the first beam, the second beam has a first contact point with the first patch under the second beam and a second contact point with the second patch under the second beam, and the third beam has a first contact point with the first patch under the third beam and a second contact point with the second patch under the third beam.

10. The sensor of claim 9 wherein each first patch and each second patch are a downward pressure sensor.

11. The sensor of claim 10 including a spring disposed under the first beam and between the first contact point and the second contact point to support the first beam.

12. The sensor of claim 11 wherein the first guide has a first post and a second post with the first rod disposed between the first post and the second post.

13. The sensor of claim 4 wherein the contact surface includes a first bump, a second bump, and a third bump; the first sensing element includes a first top layer to which the first bump is attached, a first bottom layer having at least a portion disposed under the first top layer, and a second bottom layer having at least a portion disposed under the first top layer; the second sensing element includes a second top layer to which the second bump is attached, a third bottom layer having at least a portion disposed under the second top layer, and a fourth bottom layer having at least a portion disposed under the second top layer; and the third sensing element includes a third top layer to which the third bump is attached, a fifth bottom layer having at least a portion disposed under the third top layer, and a sixth bottom layer having at least a portion disposed under the third top layer.

14. The sensor of claim 13 wherein the first, second and third top layers each includes a substrate in contact with the first, second and third bumps, respectively, the power trace in contact with the substrate, a variable force resistive material in contact with the power trace with the power trace between the substrate and the force resistive material, and adhesive in contact with the force resistive material; and each bottom layer comprises force resistive material, the return trace in contact with the variable force resistive material of the bottom layer, and a substrate in contact with the force resistive material of the bottom layer with the force resistive material of the bottom layer between the substrate of the bottom layer and the return trace.

15. The sensor of claim 14 wherein the return trace of the first bottom layer is a first return trace, the return trace of the second bottom layer is a second return trace, the return trace of the third bottom layer is a third return trace, the return trace of the fourth bottom layer is a fourth return trace, the return trace of the fifth bottom layer is a fifth return trace, and the return trace of the sixth bottom layer is a sixth return trace.

16. The sensor of claim 15 wherein the force resistive material of the first top layer contacts the force resistive material of the first bottom layer and the second bottom layer with the adhesive of the first top layer disposed between the first top layer and the first and second bottom layers where there is no force resistive material; the force resistive material of the second top layer contacts the force resistive material of the third bottom layer and the fourth bottom layer with the adhesive of the second top layer disposed between the second top layer and the third and fourth bottom layers where there is no force resistive material; and the force resistive material of the third top layer contacts the force resistive material of the fifth bottom layer and the sixth bottom layer with the adhesive of the third top layer disposed between the third top layer and the fifth and sixth bottom layers where there is no force resistive material.

17. A robotic hand comprising:
a finger having a tip; and
a plurality of sensors on the fingertip which together function as a 5° of freedom sensor over the fingertip, each sensor of the plurality of sensors is a 6° of freedom sensor.

18. A sensor comprising:
six sensor elements with a touch layer, each of the sensor elements varies current in response to compressive forces upon the touch layer;
a ribbon cable having a power trace to provide power to the six sensor elements, and six return traces upon which signals from the six sensor elements are sent, with one return trace of the six return traces connected to one sensor element of the six sensor elements; and
a computer connected to the power trace and the six return traces to provide power to the six sensor elements and receive signals from the six sensor elements.

19. A method for sensing forces comprising the steps of:
applying a force to a touch layer,
sending prompting signals to a plurality of sensing elements by a computer,
receiving data signals from the sensing elements by the computer; and
identifying six degrees of freedom of the force on the layer by the computer from the data signals received from the sensing elements.
